(19) United States
(12) Patent Application Publication
(10) Pub. No.: US 2017/0094123 A1
(43) Pub. Date: Mar. 30, 2017

(54) ELECTRONIC DEVICE, INFORMATION PROCESSING SYSTEM, AND INFORMATION PROCESSING METHOD

(71) Applicant: Minami Ogawa, Tokyo (JP)

(72) Inventor: Minami Ogawa, Tokyo (JP)

(73) Assignee: Ricoh Company, Ltd., Tokyo (JP)

(21) Appl. No.: 15/275,568

(22) Filed: Sep. 26, 2016

(30) Foreign Application Priority Data
Sep. 30, 2015 (JP) 2015-194988

(51) Int. Cl. H04N 1/44; H04L 29/06; H04N 1/00

(52) U.S. Cl. CPC H04N 1/4433; H04N 1/00344; H04N 1/00464; H04L 63/08; H04N 2201/0094

(57) ABSTRACT

An electronic device receives a service relating to an application that is in cooperation with a first service providing system from a second service providing system. The electronic device includes a data storing unit configured to store authentication information, which includes information for authenticating an organization to which a user belongs and information for identifying the service, after authentication processing performed on the first service providing system succeeds; and a requesting unit configured, in a case where the authentication information has been stored in the data storing unit when a request to use the service is received from the user, to use the authentication information stored in the data storing unit to request the second service providing system to provide the service.

### CROSS-REFERENCE TO RELATED APPLICATIONS

The present application claims the benefit of priority under 35 U.S.C. §119 of Japanese Patent Application No. 2015-194988 filed on Sep. 30, 2015, the contents of which are incorporated herein by reference in their entirety.

### BACKGROUND OF THE INVENTION

1. Field of the Invention

The disclosures herein generally relate to an electronic device, an information processing system, and an information processing method.

2. Description of the Related Art

Recently, an information processing system that uses, from a multifunction peripheral, a multi-tenant service or an application that is in cooperation with an external service such as an online storage is becoming popular. Authentication is generally performed in order to use the multi-tenant service or the application that is in cooperation with the external service in the information processing system as described above.

A system that includes a first service providing system, which provides a service to a device, and a second service providing system having an authentication infrastructure different from an authentication infrastructure of the first service providing system is known in the related art. In such a system, authority information on the second service providing system is stored in the first service providing system. Thereby, the second service providing system becomes also available when authentication processing is once performed on the first service providing system (for example, see Japanese Unexamined Patent Application Publication No. 2014-112354).

For example, in the information processing system that uses, from an electronic device such as the multifunction peripheral, the application that is in cooperation with the external service, it is required to perform authentication in the electronic device every time the application is used.

### SUMMARY OF THE INVENTION

It is a general object of at least one embodiment of the present disclosure to provide an electronic device, an information processing system, and an information processing method that substantially obviate one or more problems caused by the limitations and disadvantages of the related art.

According to one aspect of the present disclosure, there is provided an electronic device for receiving a service relating to an application that is in cooperation with a first service providing system from a second service providing system. The electronic device includes a data storing unit configured to store authentication information, which includes information for authenticating an organization to which a user belongs and information for identifying the service, after authentication processing performed on the first service providing system succeeds; and a requesting unit configured, in a case where the authentication information has been stored in the data storing unit when a request to use the service is received from the user, to use the authentication information stored in the data storing unit to request the second service providing system to provide the service.

### BRIEF DESCRIPTION OF THE DRAWINGS

FIG. 1 is a block diagram illustrating an example of a system configuration of an information processing system according to a first embodiment;

FIG. 2 is a block diagram illustrating an example of a hardware configuration of a computer according to the first embodiment;

FIG. 3 is a block diagram illustrating an example of a hardware configuration of an image forming apparatus according to the first embodiment;

FIG. 4 is a block diagram illustrating an example of elements of the information processing system according to the first embodiment;

FIG. 5 is a table illustrating an example of tenant information;

FIG. 6 is a table illustrating an example of user information;

FIG. 7 is a table illustrating an example of external cooperation information;

FIG. 8 is a table illustrating an example of application information;

FIG. 9 is a diagram illustrating an example of an operation flow of the information processing system according to the first embodiment;

FIG. 10 is a sequence chart (part 1) illustrating an example of processing for displaying an application screen when an application is activated for the first time;

FIG. 11 is a sequence chart (part 2) illustrating the example of the processing for displaying the application screen when the application is activated for the first time;

FIG. 12 is a table illustrating an example of tenant authentication information;

FIG. 13 is a diagram illustrating an operation flow when the application is activated for the second or more time;

FIG. 14 is a sequence chart illustrating an example of processing for displaying the application screen when the application is activated for the second or more time;

FIG. 15 is a sequence chart illustrating an example of processing for displaying the application screen in a case where the application information is cached;

FIG. 16 is a diagram illustrating an example of an operation flow of an information processing system according to a second embodiment;

FIG. 17 is a sequence chart (part 1) illustrating an example of processing for displaying an application screen for personal use;

FIG. 18 is a sequence chart (part 2) illustrating the example of the processing for displaying the application screen for personal use;

FIG. 19 is a table illustrating an example of application information for personal use;

FIG. 20 is a sequence chart (part 1) illustrating another example of processing for displaying the application screen for personal use;

FIG. 21 is a sequence chart (part 2) illustrating the other example of the processing for displaying the application screen for personal use; and

FIG. 22 is a flowchart illustrating an example of a case where an authentication mode is used to perform personal authentication.

### DESCRIPTION OF THE PREFERRED EMBODIMENTS

In the following, embodiments of the present disclosure will be described with reference to the accompanying drawings. An object of one embodiment is to provide an electronic device that can reduce labor of authentication processing when an application that is in cooperation with an external service is used on the electronic device.

### First Embodiment

### System Configuration

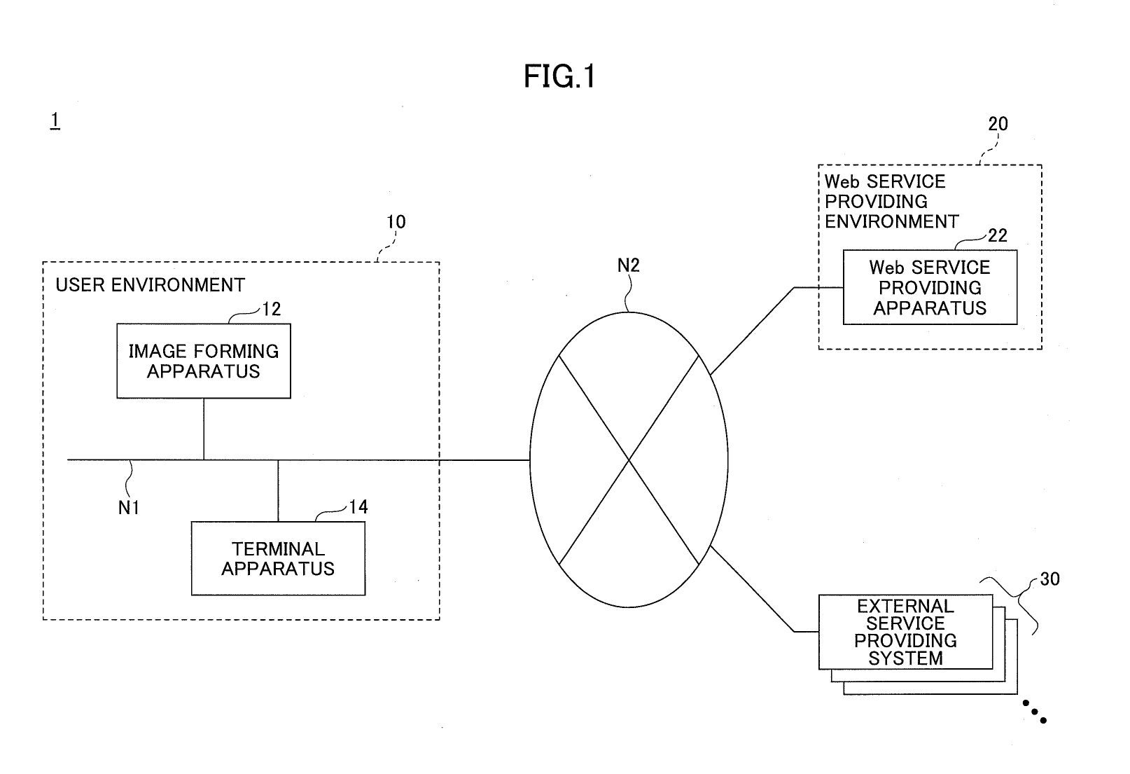

FIG. 1 is a block diagram illustrating an example of a system configuration of an information processing system 1 according to a first embodiment. In the information processing system 1 illustrated in FIG. 1, a user environment 10, a Web service providing environment 20, and one or more external service providing systems 30 are connected with each other via a network N2 such as the INTERNET.

The user environment 10 is a system of an organization of a user company (enterprise) or the like of the image forming apparatus 12. In the user environment 10, one or more image forming apparatuses 12 and one or more terminal apparatuses 14 are connected via a network N1 such as a Local Area Network (LAN). The image forming apparatus 12 is an example of an electronic device.

The electronic apparatus according to the first embodiment includes (may be) the image forming apparatus such as a multifunction peripheral, a scanner, a printer, a facsimile, a projector, and an electronic blackboard and various electronic apparatuses executing a job in conformity with a job setup. For example, the image forming apparatus 12 performs image forming processing such as scan, print (output), and facsimile (FAX).

The terminal apparatus 14 is an apparatus that a user or a manager (administrator) of the image forming apparatus 12 in the user environment 10 operates. For example, the terminal apparatus 14 may be a Personal Computer (PC), a tablet terminal, a smartphone, a mobile phone, or a Personal Digital Assistance (PDA).

The Web service providing environment 20 is a system of an organization such as a service company that provides a Web service via the network N2 such as a cloud scan service and a cloud print service. The Web service providing environment 20 includes a Web service providing apparatus 22. Although the web service is described as an example, the first embodiment is applicable to a service provided by an application service provider (ASP) and a cloud service, which are provided through the network N2.

The web service providing apparatus 22 provides the web service such as the cloud scan service and the cloud print service to the image forming apparatus 12 through the network N2. For example, the cloud scan service is to store image data scanned by the image forming apparatus 12 of the user environment 10 in a predetermined storage destination (a storage area) such as an online storage provided by the external service providing system 30. The cloud print service is to print print data stored in a predetermined storage destination such as an online storage service provided by the external service providing system 30 using the image forming apparatus 12 of the user environment 10. In other words, the image forming apparatus 12 receives a service relating to an application that is in cooperation with the external service providing system 30 from the web service providing apparatus 22.

The external service providing system 30 provides, for example, a service such as the online storage service through the network N2. In the first embodiment, the service such as the cloud service provided by the external service providing system 30 is referred to as an “external service” in order to distinguish this service from the web service provided by the web service providing apparatus 22.

In FIG. 1, the network N1 of the information processing system 1 may be a wired communication network or a wireless communication network. The information processing system 1 illustrated in FIG. 1 is an example of a system configuration. For example, the web service providing apparatus 22 of the web service providing environment 20 may be formed by a plurality of computers, to which functions of the web service providing apparatus 22 are distributed.

<Hardware Configuration>

<<Computer>>

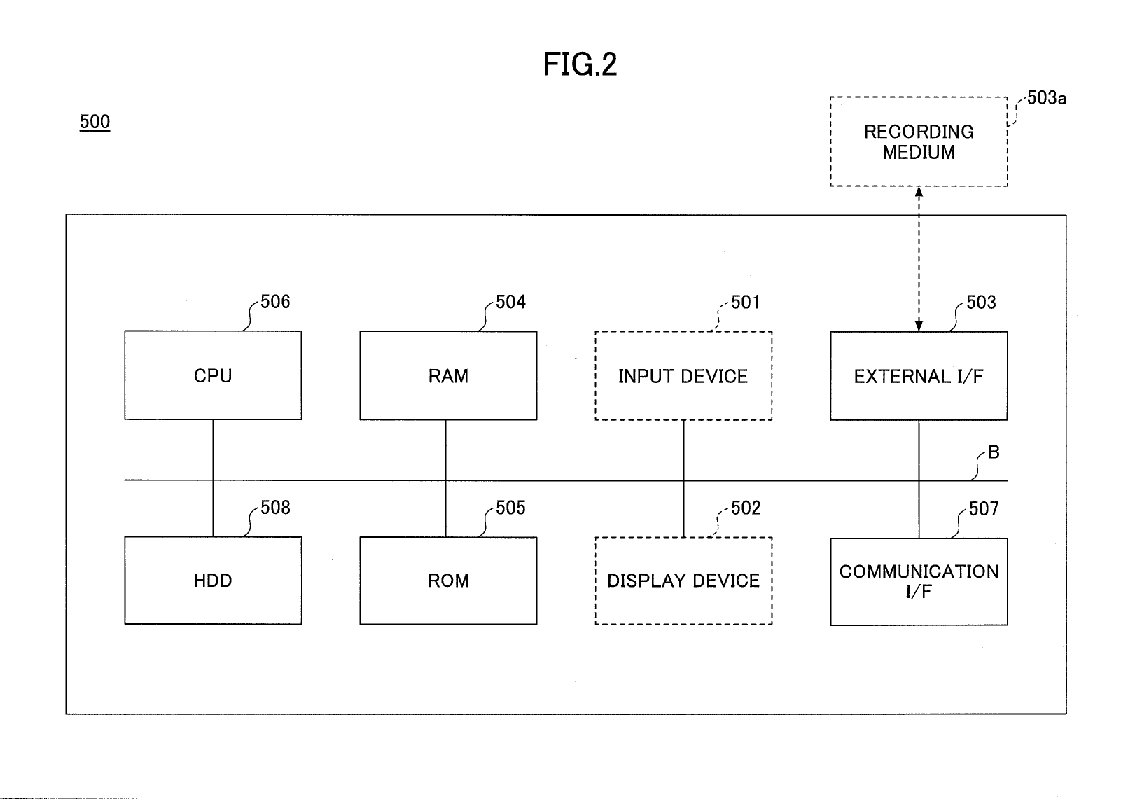

For example, the terminal apparatus 14, the web service providing apparatus 22, and the external service providing system 30 may be actualized by a computer 500 having a hardware configuration illustrated in FIG. 2. FIG. 2 is a block diagram illustrating an example of a hardware configuration of the computer 500 according to the first embodiment.

The computer 500 illustrated in FIG. 2 includes an input device 501, a display device 502, an external I/F 503, a RAM (Random Access Memory) 504, a ROM (Read Only Memory) 505, a CPU (Central Processing Unit) 506, a communication I/F 507, a HDD (Hard Disk Drive) 508 and the like that are connected with each other via a bus B. Here, the input device 501 and the display device 502 may be connected only when they are necessary.

The input device 501 includes a keyboard, a mouse, a touch panel, and the like. The user can use the input device 501 to input various operation signals. The display device 502 includes a display or the like to display a processing result obtained by the computer 500.

The communication I/F 507 is an interface that connects the computer 500 to various networks. With this configuration, the computer 500 can perform data communication via the communication I/F 507.

The HDD 508 is an example of a non-volatile memory device that stores programs and/or data. The stored programs and/or data may include operating system (OS), which is basic software for controlling the entire computer 500, application software (hereinafter, simply referred to as an “application”) providing various functions in the OS, and so on. The computer 500 may use a drive device using a flash memory (e.g., a solid state drive (SSD)) as a memory medium instead of the HDD 508.

The external I/F 503 is an interface with an external apparatus. The external apparatus may be a recording medium 503a or the like. The computer 500 can read information (data) from the recording medium 503a and/or write information (data) to the recording medium 503a through the external I/F 503. The recording medium 503a may be a flexible disk, a CD, a DVD, an SD memory card, a USB memory, or the like.

The ROM 505 is an example of a non-volatile semiconductor memory (a memory device), which can hold (store) programs and/or data even when a power source is powered off. The ROM 505 stores programs and/or data such as basic input/output system (BIOS), OS setup, and network setup, which are executed when the computer 500 is activated. The RAM 504 is an example of a volatile semiconductor memory (a memory device) that temporarily stores the programs and/or the data.

The CPU 506 reads, from the memory device such as the ROM 505 and the HDD 508, the program(s) and/or the data into the RAM 504 to execute processing. The CPU 506 is an arithmetic unit that actualizes control and functions of the entire computer 500.

The terminal apparatus 14, the web service providing apparatus 22, and the external service providing system 30 actualize various kinds of processing, which will be described later, with the hardware configuration of the computer 500 illustrated in, for example, FIG. 2.

<<Image Forming Apparatus>>

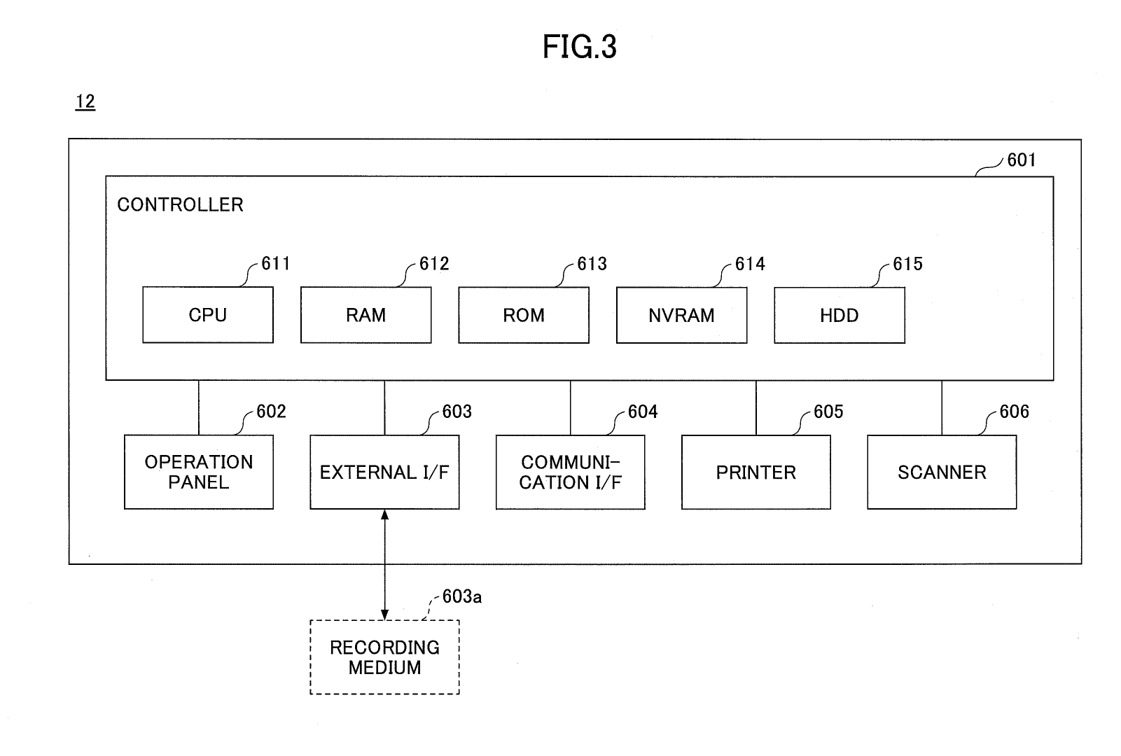

The image forming apparatus 12 illustrated in FIG. 1 is actualized by a computer having a hardware configuration as illustrated in FIG. 3, for example. FIG. 3 is a block diagram illustrating an example of a hardware configuration of the image forming apparatus 12 according to the first embodiment. The image forming apparatus 12 illustrated in FIG. 3 includes a controller 601, an operation panel 602, an external I/F 603, a communication I/F 604, a printer 605, a scanner 606 and the like.

The controller 601 includes a CPU 611, a RAM 612, a ROM 613, a NVRAM 614, a HDD 615 and the like. The ROM 613 stores various programs and/or data. The RAM 612 temporarily stores programs and/or data. The NVRAM 614 stores setup information and the like, for example. The HDD 615 stores various programs and/or data.

The CPU 611 reads the program(s), the data, the setup information, or the like into the RAM 612 from the ROM 613, the NVRAM 614, the HDD 615, or the like to execute the processing. Thereby, the CPU 611 actualizes control and functions of the entire image forming apparatus 12.

The operation panel 602 includes an input unit that receives input from a user and a display unit that displays data, an image, and/or the like. The external I/F 603 is an interface with an external device. A recording medium 603a or the like may be the external device. The image forming apparatus 12 can read and/or write information (data) from and/or on the recording medium 603a via the external I/F 603. An IC card, a flexible disk, a CD, a DVD, an SD memory card, a USB memory or the like may be the recording medium 603a.

The communication I/F 604 is an interface that connects the image forming apparatus 12 to the network N2. The image forming apparatus 12 can perform data communication via the communication I/F 604. The printer 605 is a printing device that prints print data on a paper (sheet). The scanner 606 is a reading device that reads image data (electronic data) from a document.

<Software Configuration>

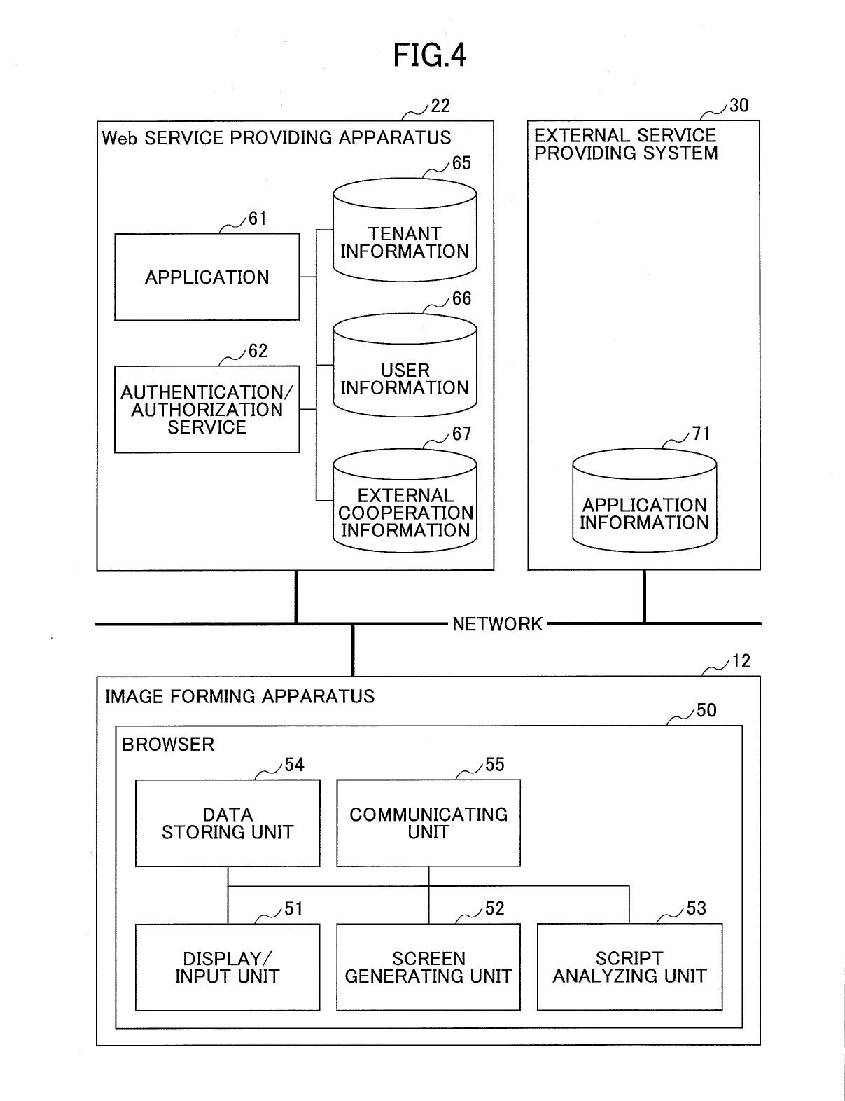

The image forming apparatus 12, the Web service providing apparatus 22, and the external service providing system 30 according to the first embodiment are actualized by processing blocks (elements) illustrated in FIG. 4, for example. FIG. 4 is a block diagram illustrating an example of elements of the information processing system 1 according to the first embodiment.

The image forming apparatus 12 of FIG. 4 included in the information processing system 1 has a browser 50. The image forming apparatus 12 actualizes a display/input unit 51, a screen generating unit 52, a script analyzing (interpreting) unit 53, a data storing unit 54 and a communicating unit 55 with the browser 50. In other words, the image forming apparatus 12 includes these elements.

The Web service providing apparatus 22 of FIG. 4 included in the information processing system 1 executes one or more programs to actualize an application 61 and an authentication/authorization service 62. The Web service providing apparatus 22 holds (stores) tenant information 65, user information 66, and external cooperation information 67 that will be described later. The external service providing system 30 of FIG. 4 included in the information processing system 1 holds (stores) application information 71 that will be described later.

The browser 50 of the image forming apparatus 12 obtains a static file and uses the Web service and the external service via the communicating unit 55. The screen generating unit 52 performs rendering and parsing on an obtained HTML file. The script analyzing unit 53 analyzes and executes script language such as JavaScript (registered trademark). The data storing unit 54 is a storage area such as a local storage and a session storage. The display/input unit 51 displays various screens for the user and receives various input operations from the user.

The application 61 of the Web service providing apparatus 22 provides various Web services to the image forming apparatus 12. The authentication/authorization service 62 provides an authentication/authorization service to the image forming apparatus 12.

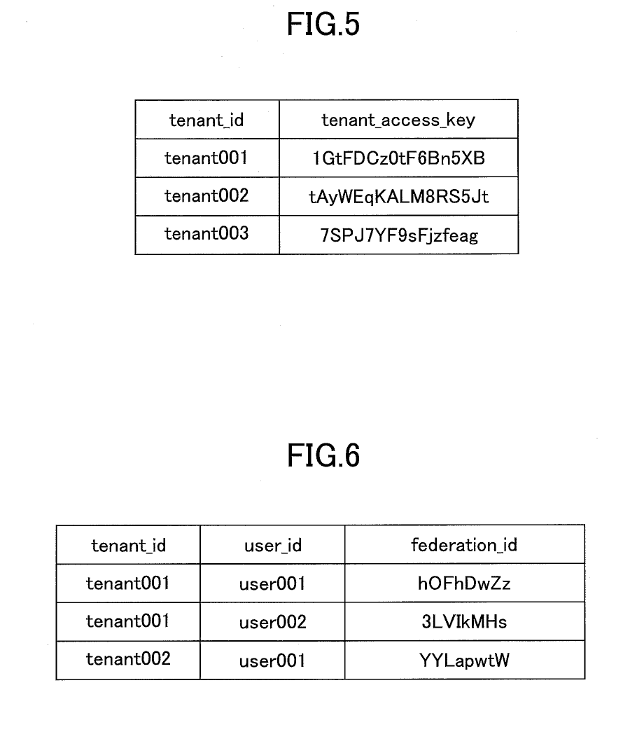

For example, the tenant information 65 is a table (configuration) as illustrated in FIG. 5. FIG. 5 is a table illustrating an example of the tenant information 65. In the tenant information 65 of FIG. 5, tenant IDs are associated with tenant access keys.

The tenant ID is an example of identification information for uniquely identifying a tenant. Here, the tenant ID represents a group (organization) such as a company and a department. The tenant access key is an example of a tenant authentication key and is information for authenticating the tenant.

For example, the user information 66 is a table (configuration) as illustrated in FIG. 6. FIG. 6 is a table illustrating an example of the user information 66. In the user information 66 of FIG. 6, tenant IDs are associated with user IDs, and federation IDs. The user ID is an example of identification information for uniquely identifying a user. The federation ID is an example of an external cooperation ID and is information for identifying an external service.

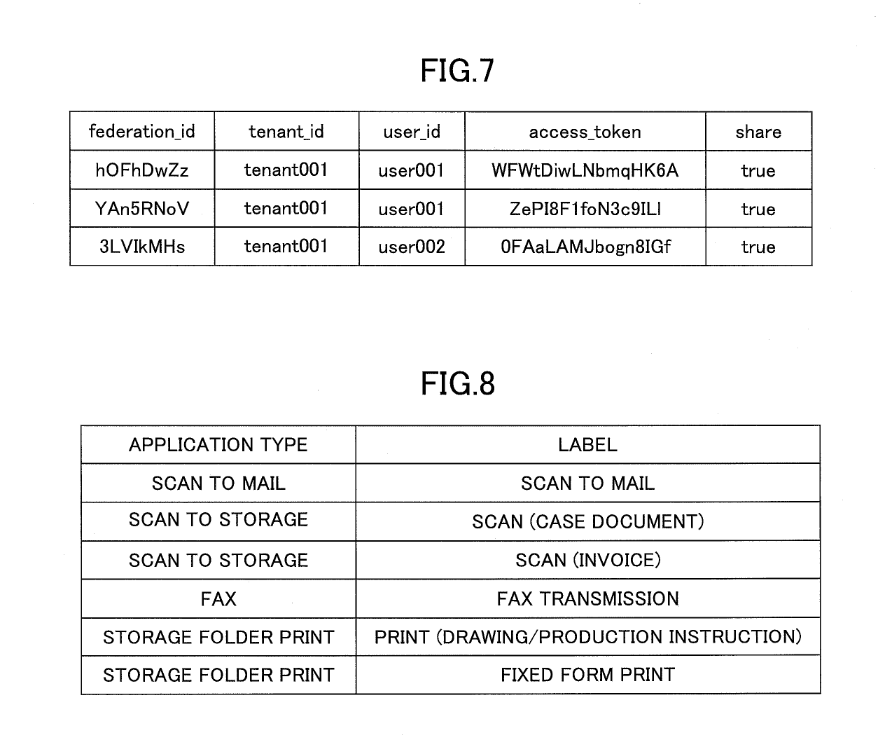

For example, the external cooperation information 67 is a table (configuration) as illustrated in FIG. 7. FIG. 7 is a table illustrating an example of the external cooperation information 67. In the external cooperation information 67 of FIG. 7, the federation IDs are associated with the tenant IDs, the user IDs, access tokens, and information items that represent whether to share.

The access token is an example of a token to access the external service providing system 30. The Web service providing apparatus 22 can use the access token to obtain the application information 71 as illustrated in FIG. 8 from the external service providing system 30.

FIG. 8 is a table illustrating an example of the application information 71. In the application information 71 of FIG. 8, application types are associated with labels. The application type is an example of information that represents a type of a Web service that the Web service providing apparatus 22 provides. The label is a name of the Web service displayed on an application screen that will be described later. The Web service providing apparatus 22 can use the application information 71 of FIG. 8 to display the application screen that will be descried later.

<Details of Processing>

In the following, details of processing of the information processing system 1 according to the first embodiment are described.

<Operation Flow>

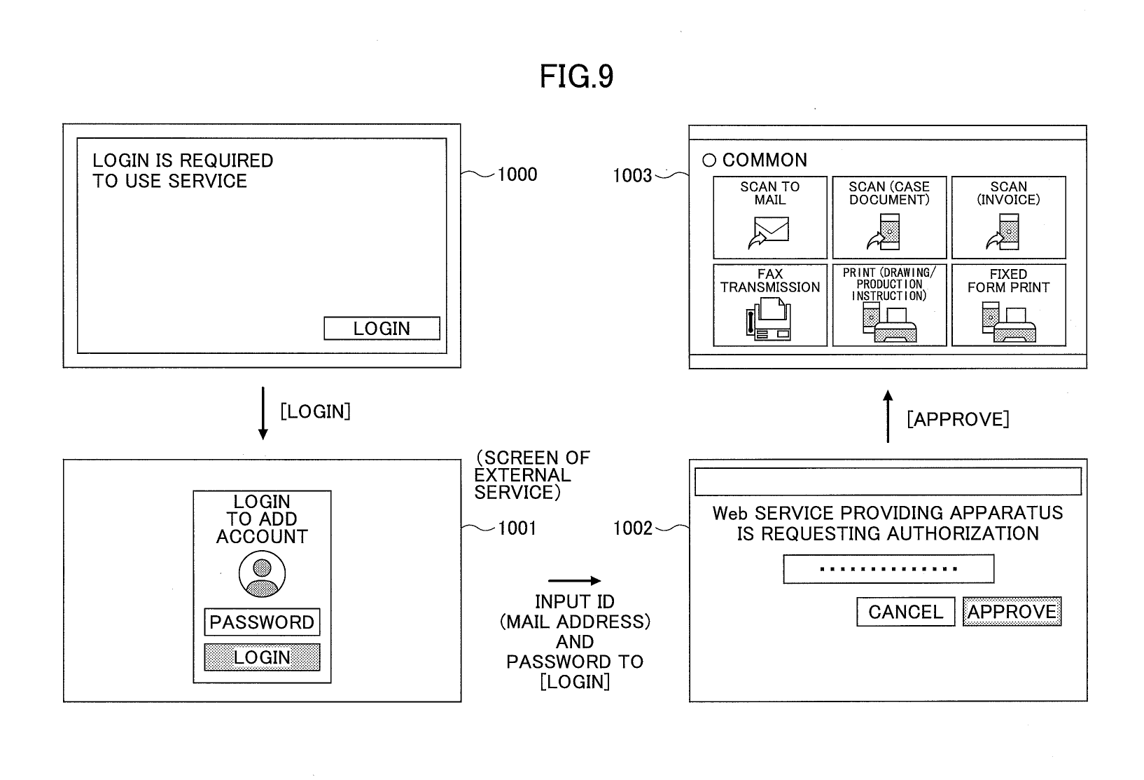

For example, when the application 61 is activated for first time, the manager or the user performs an operation according to procedures illustrated in FIG. 9 to display an application screen 1003. FIG. 9 is a diagram illustrating an example of an operation flow of the information processing system 1 according to the first embodiment.

When the application 61 is activated for the first time, the image forming apparatus 12 displays a screen 1000 that prompts login because the login has not been performed yet. When the user pushes a login button of the screen 1000, which prompts the login, the image forming apparatus 12 displays an authorization screen 1001 of the external service providing system 30 obtained from the external service providing system 30.

The user inputs an ID (mail address) and a password to the authorization screen 1001 and pushes an approve button in an approval screen 1002 to request authorization processing. When the authorization is successful, the image forming apparatus 12 obtains the application information from the external service providing system 30, and uses the obtained application information to display an application screen 1003.

<<Activation for the First Time>>

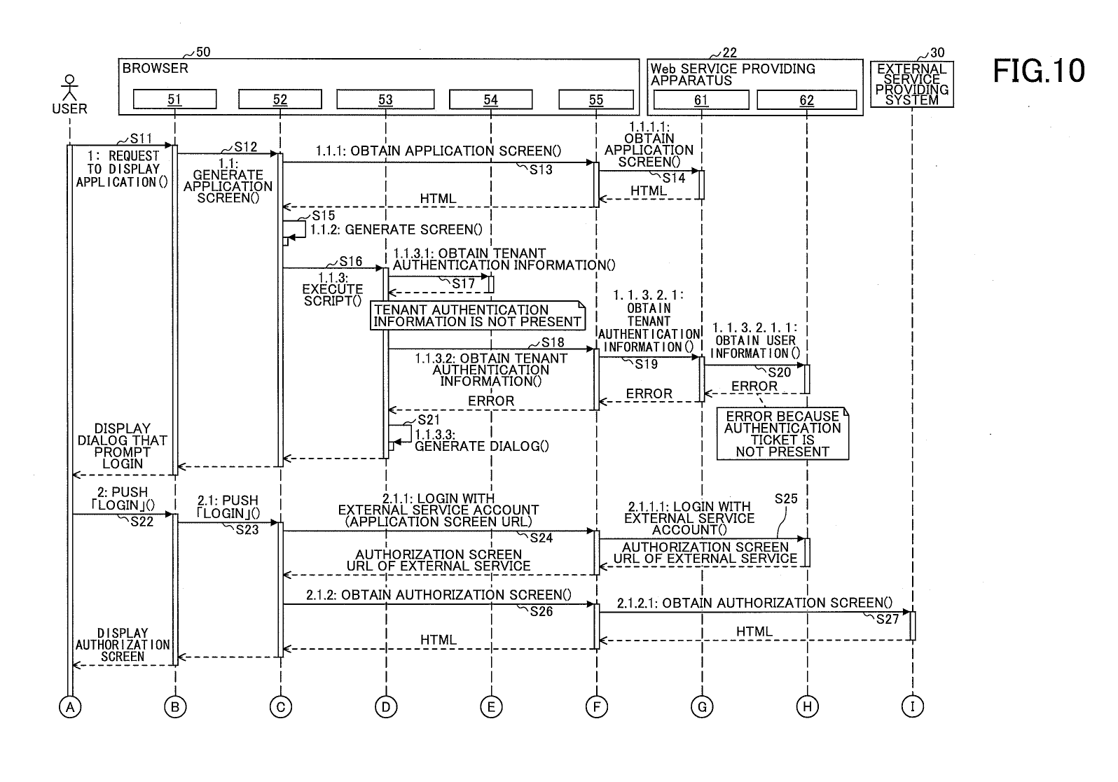

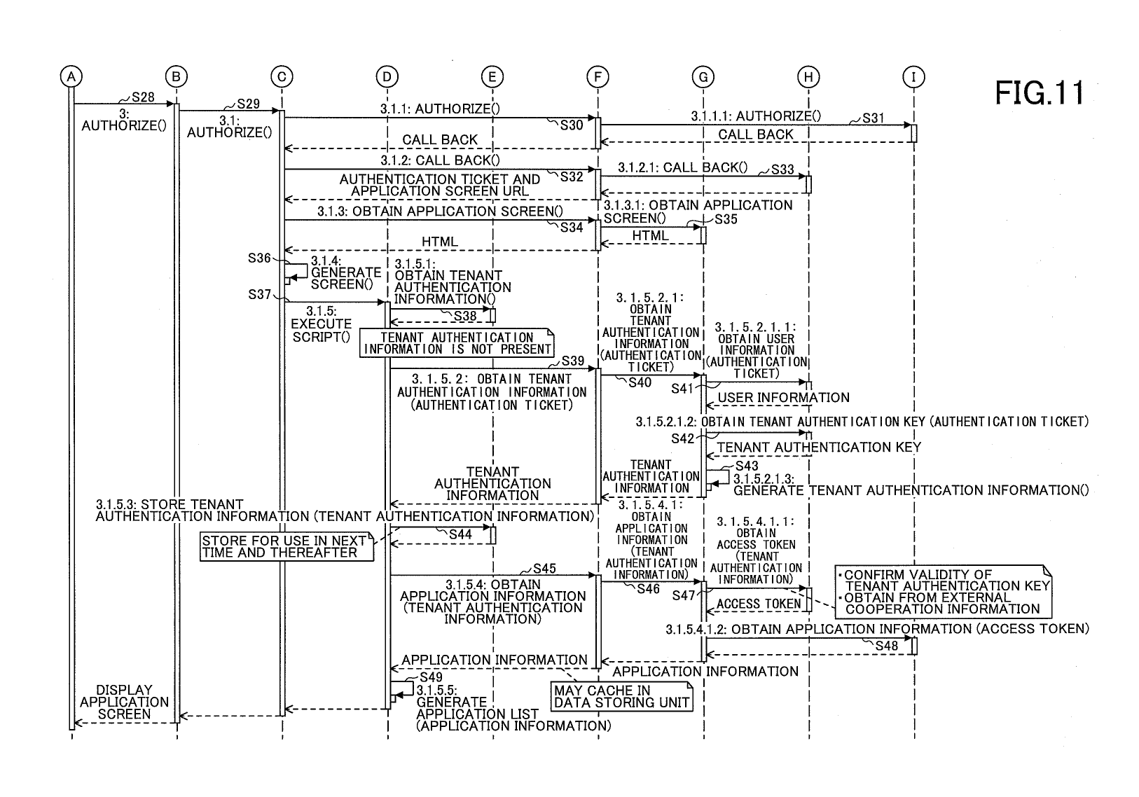

When the application 61 is activated by the manager or the user for the first time, the image forming apparatus 12 displays the application screen 1003 according to procedures as illustrated in FIGS. 10 and 11. FIGS. 10 and 11 illustrate a sequence chart illustrating an example of processing for displaying an application screen when the application 61 is activated for the first time.

In step S11, the user operates the display/input unit 51 of the image forming apparatus 12 to make a request to display the application. In step S12, the display/input unit 51 requests the screen generating unit 52 to generate the application screen. In steps S13 and S14, the screen generating unit 52 obtains HTML data of the application screen 1003 from the application 61 of the Web service providing apparatus 22 via the communicating unit 55.

In step S15, the screen generating unit 52 generates the application screen 1003 by use of the obtained HTML data. Further, in step S16, the screen generating unit 52 requests the script analyzing unit 53 to execute the script included in the obtained HTML data. In other words, the screen generating unit 52 obtains screen data for generating the screen of the service, from the Web service providing apparatus 22, to cause the script analyzing unit 53 to execute a program included in the screen data. The script analyzing unit 53 executes the script included in the HTML data to perform subsequent processing.

In step S17, the script analyzing unit 53 checks whether tenant authentication information has been stored in the data storing unit 54. Because the application 61 is activated for the first time in this case, the tenant information has not been stored in the data storing unit 54.

When the tenant information has not been stored in the data storing unit 54, the script analyzing unit 53 requests the application 61 of the Web service providing apparatus 22 to obtain the tenant authentication information in steps S18 and S19. In step S20, the application 61 requests the authentication/authorization service 62 to obtain user information.

However, because an authentication ticket is not included in the request to obtain the user information, the authentication/authorization service 62 returns an error to the script analyzing unit 53 of the image forming apparatus 12. In step S21, the script analyzing unit 53, which receives the error, generates a dialog of the screen 1000 that prompts the login and displays the screen 1000, which prompts the login, on the display/input unit 51. In other words, the display/input unit 51 displays a screen for prompting the user to perform the authentication processing on the external service providing system 30 in a case where the tenant authentication information has not been stored in the data storing unit 54 when the request to use the service is received from the user.

In step S22, the user pushes the login button of the screen 1000, which prompts the login. In step S23, the display/input unit 51 of the image forming apparatus 12 notifies the screen generating unit 52 that the login button of the screen 1000, which prompts the login, is pushed.

In steps S24 and S25, the screen generating unit 52 designates a URL of the application screen to perform, on the authentication/authorization service 62 of the Web service providing apparatus 22, the login with an account of an external service. The authentication/authorization service 62 returns a URL of the authorization screen 1001 of the external service providing system 30 to the screen generating unit 52 of the image forming apparatus 12.

In steps S26 and S27, the screen generating unit 52 uses the URL of the authorization screen 1001 returned from the Web service providing apparatus 22 to obtain HTML data of the authorization screen 1001 from the external service providing system 30. The screen generating unit 52 uses the obtained HTML data of the authorization screen 1001 to cause the display/input unit 51 to display the authorization screen 1001.

In step S28, the user inputs the ID (mail address) and the password in the authorization screen 1001 and pushes the approve button in the approval screen 1002 to request authorization processing to the display/input unit 51 of the image forming apparatus 12. In step S29, the display/input unit 51 requests the authorization processing to the screen generating unit 52.

In steps S30 and S31, the screen generating unit 52 requests, to the external service providing system 30, the authorization processing by the password and the ID (mail address) input to the authorization screen 1001. A result of the authorization processing in the external service providing system 30 is called back (returned) to the authentication/authorization service 62 of the Web service providing apparatus 22 in steps S32 and S33. When the authorization processing is successful in the external service providing system 30, the authentication/authorization service 62 returns (transmits) the authentication ticket and the URL of the application screen 1003 to the screen generating unit 52 of the image forming apparatus 12.

Here, because processes in steps S34 to S38 are similar to the processes in steps S13 to S17, descriptions of the processes in steps S34 to S38 are omitted. Because the tenant authentication information has not been stored in the data storing unit 54, the script analyzing unit 53 designates the authentication ticket and requests the application 61 of the Web service providing apparatus 22 to obtain the tenant authentication information in steps S39 and S40.

In step S41, the application 61 designates the authentication ticket and requests the authentication/authorization service 62 to obtain user information. Because the authentication ticket is included in the request to obtain the user information, the authentication/authorization service 62 returns the user information 66 of FIG. 6 to the application 61. Further, in step S42, the application 61 designates the authentication ticket to request the authentication/authorization service 62 to obtain a tenant authentication key (tenant access key). Because the authentication ticket is included in the request to obtain the tenant authentication key (tenant access key), the authentication/authorization service 62 returns the tenant access key of FIG. 5 to the application 61.

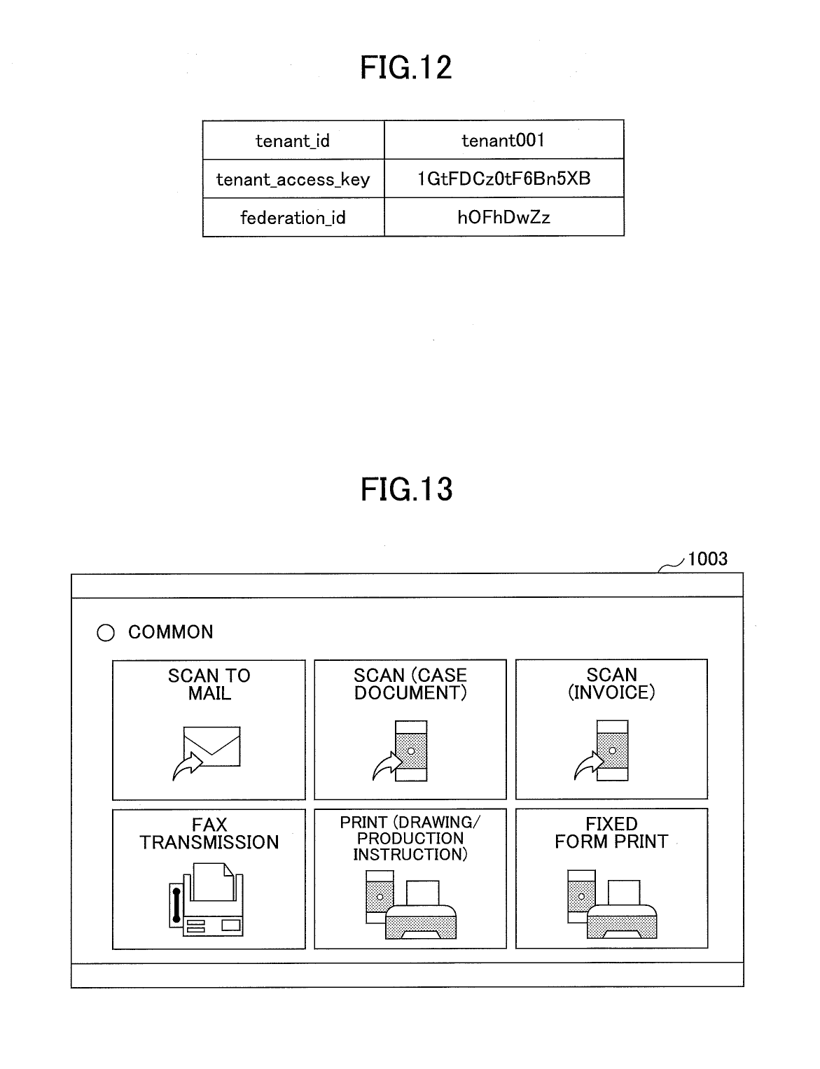

In step S43, the application 61 generates tenant authentication information as illustrated in FIG. 12 from the user information obtained in step S41 and the tenant access key obtained in step S42. FIG. 12 is a table illustrating an example of the tenant authentication information. In the tenant authentication information of FIG. 12, the tenant ID, the tenant access key, and the federation ID are associated with each other.

The application 61 returns the generated tenant authentication information to the script analyzing unit 53 of the image forming apparatus 12. In step S44, the script analyzing unit 53 stores the tenant authentication information in the data storing unit 54 in order to use the tenant authentication information for the next time the application 61 is activated. In other words, after authentication processing performed on the external service providing system 30 succeeds, the data storing unit 54 stores the tenant authentication information, which includes information for authenticating an organization to which a user belongs and information for identifying a service. In steps S45 and S46, the script analyzing unit 53 designates (uses) the tenant authentication information to request the application 61 of the Web service providing apparatus 22 to obtain the application information.

In step S47, the application 61 designates the tenant authentication information of FIG. 12 to request the authentication/authorization service 62 to obtain an access token. The authentication/authorization service 62 confirms validity of the tenant access key of the designated tenant access information. When the validity is confirmed, the authentication/authorization service 62 obtains, from the external cooperation information 67 of FIG. 7, the access token having the same federation ID and the same tenant ID with the tenant authentication information. In this case, the access token “WFWtDiwLNbmqHK6A” is obtained. The authentication/authorization service 62 returns the obtained access token to the application 61. In other words, the authentication/authorization service 62 can provide information for using the external service providing system 30 in response to a request from the script analyzing unit 53 using the tenant authentication information.

In step S48, the application 61 designates the access token to obtain the application information as illustrated in FIG. 8 from the external service providing system 30, and returns the obtained application information to the script analyzing unit 53. In other words, the application 61 can use the external service providing system 30 by use of the information for using the external service providing system 30 to perform processing for providing the service requested from the script analyzing unit 53. Here, the script analyzing unit 53 may cache the application information obtained from the external service providing system 30 in the data storing unit 54. In step S49, the script analyzing unit 53 generates an application list from the application information to display the application screen 1003 including the application list on the display/input unit 51.

<<Activation for the Second or More Time>>

When the application 61 is activated for the second or more time, the image forming apparatus 12 immediately displays the application screen 1003 as illustrated in FIG. 13. FIG. 13 is a diagram illustrating an operation flow when the application 61 is activated for the second or more time. When the application 61 is activated for the second or more time, the image forming apparatus 12 can obtain the application information by use of the tenant authentication information of FIG. 12 stored in the data storing unit 54. Accordingly, the image forming apparatus 12 can omit displaying of the screen 1000, which prompts the login, the authorization screen 1001, and the approval screen 1002. In this way, the image forming apparatus 12 can immediately display the application screen 1003 including the application list of the tenant of the operating user. In other words, in a case where the tenant authentication information has been stored in the data storing unit 54 when the request to use the service is received from the user, the display/input unit 51 can display a screen of the service without displaying a screen for prompting the user to perform the authentication processing on the external service providing system 30.

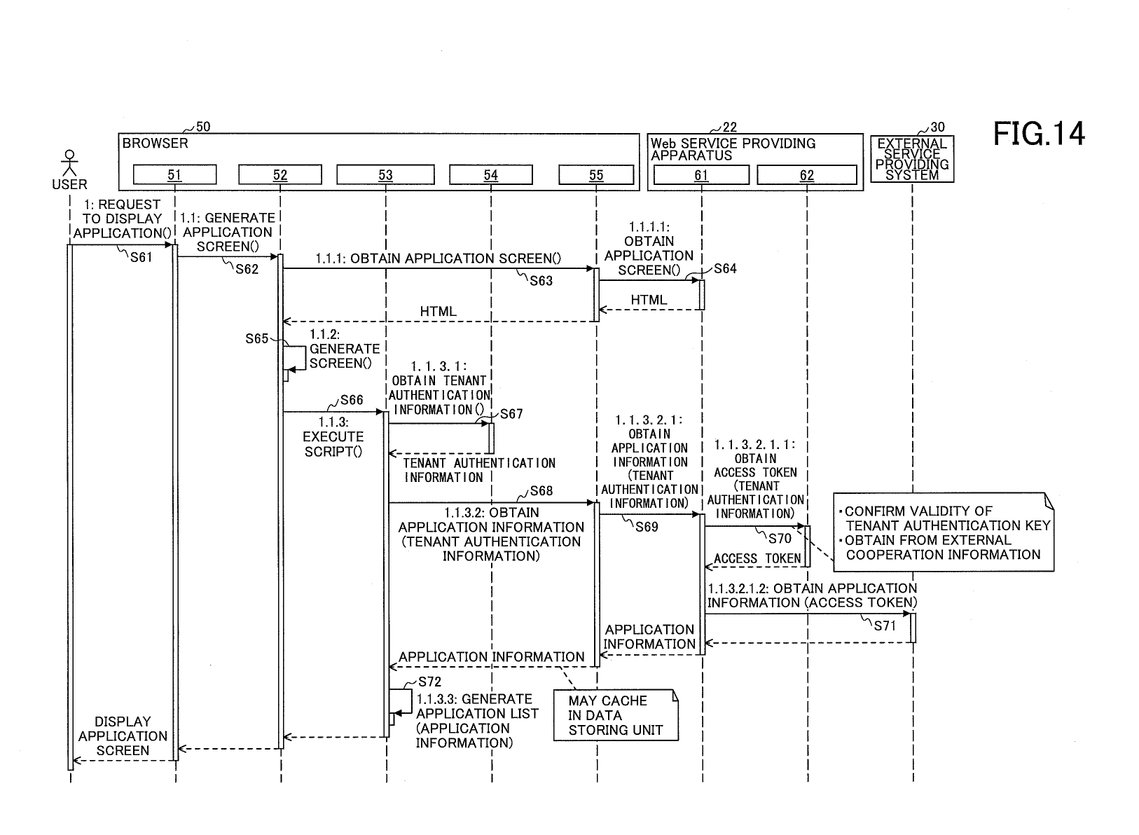

When the application 61 is activated by the user or the manager for the second or more time, the image forming apparatus 12 displays the application screen 1003 according to procedures illustrated in FIG. 14. FIG. 14 is a sequence chart illustrating an example of processing for displaying the application screen when the application 61 is activated for the second or more time.

Because processes in steps S61 to S66 are similar to the processes in steps S11 to S16, descriptions of the processes in steps S61 to S66 are omitted. In step S67, the script analyzing unit 53 checks whether tenant authentication information has been stored in the data storing unit 54.

Because the application 61 is activated for the second or more time in this case, the tenant information has been stored in the data storing unit 54. When the tenant authentication information has been stored in the data storing unit 54, the script analyzing unit 53 executes processes in step S68 to S72, which are similar to the processes in step S45 to S49 of FIG. 11, to obtain the application information from the external service providing system 30. The script analyzing unit 53 generates the application list from the application information to display the application screen 1003 including the application list on the display/input unit 51.

Further, as described above, the image forming apparatus 12 may cache the application information 71 obtained from the external service providing system 30 in the data storing unit 54 of the browser 50. Thereby, the image forming apparatus 12 can display the application screen 1003 more quickly.

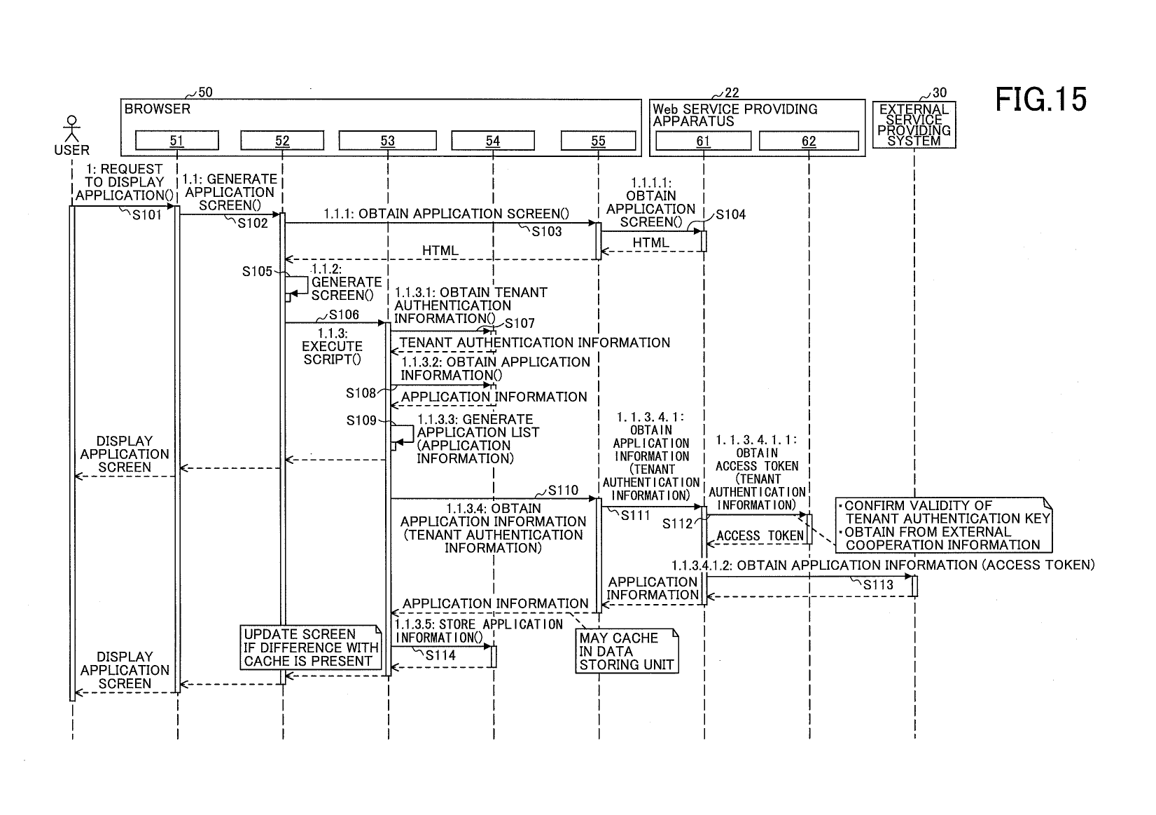

FIG. 15 is a sequence chart illustrating an example of processing for displaying the application screen in a case where the application information is cached. Because processes in step S101 to S107 are similar to the processes in step S61 to S67 of FIG. 14, descriptions of the processes in step S101 to S107 are omitted.

In step S108, the script analyzing unit 53 obtains the cached application information from the data storing unit 54. In step S109, the script analyzing unit 53 generates the application list from the application information to display the application screen 1003 including the application list on the display/input unit 51.

After displaying the application screen 1003 including the application list generated from the cached application information, the script analyzing unit 53 executes processes in step S110 to S113 that are similar to the processes in step S45 to S48 of FIG. 11. Then, the script analyzing unit 53 caches the application information obtained from the external service providing system 30 in the data storing unit 54 in step S114. When the application information cached in step S114 has a difference, the script analyzing unit 53 generates an application list from the newly obtained application information to update the application screen 1003.

According to the sequence chart illustrated in FIG. 15, it becomes possible to use the cached application information 71 to display the application screen 1003. Thereby, it becomes possible to display the application screen 1003 more quickly. Further, in the sequence chart of FIG. 15, if there is a difference between the cached application information 71 and the application information 71 of the external service providing system 30, it becomes possible to update the application screen 1003 after displaying the application screen 1003 with the cached application information 71.

<Review>

In the information processing system 1 according to the first embodiment, the image forming apparatus 12, which uses the application 61 of the Web service providing apparatus 22 in cooperation with the external service, obtains and stores the tenant authentication information when the application 61 is activated for the first time.

When the application 61 is activated for the second or more time, the image forming apparatus 12 can obtain the application information 71 from the external service providing system 30 with the access token obtained by using the stored tenant information to display the application screen 1003.

As described above, the information processing system 1 according to the first embodiment stores information (tenant access key) for authenticating the tenant and information (federation ID) for identifying the external service in the image forming apparatus 12 as the tenant authentication information at the time of first login. When the application 61 is activated for the second or more time, the information processing system 1 can use the stored tenant authentication information to obtain the access token for accessing the external service providing system 30 and can access a shared resource of the tenant stored in the external service providing system 30. In other words, in a case where the tenant authentication information has been stored in the data storing unit 54 when a request to use a service is received from the user, the script analyzing unit 53 can use the tenant authentication information stored in the data storing unit 54 to request the Web service providing apparatus 22 to provide the service.

As described above, according to the information processing system 1 of the first embodiment, when the application 61 is activated for the second or more time, it becomes possible to use the application 61 of the Web service providing apparatus 22 in cooperation with the external service without performing the login. Thereby, it becomes possible to reduce the labor of the authentication processing for the user.

### Second Embodiment

The information processing system 1 according to a second embodiment jointly uses (performs) personal authentication relative to the information processing system 1 according to the first embodiment. Descriptions of the second embodiment similar to the descriptions of the first embodiment may be omitted as appropriate.

<Details of Processing>

In the following, details of processing of the information processing system 1 according to a second embodiment are described.

<<Operation Flow>>

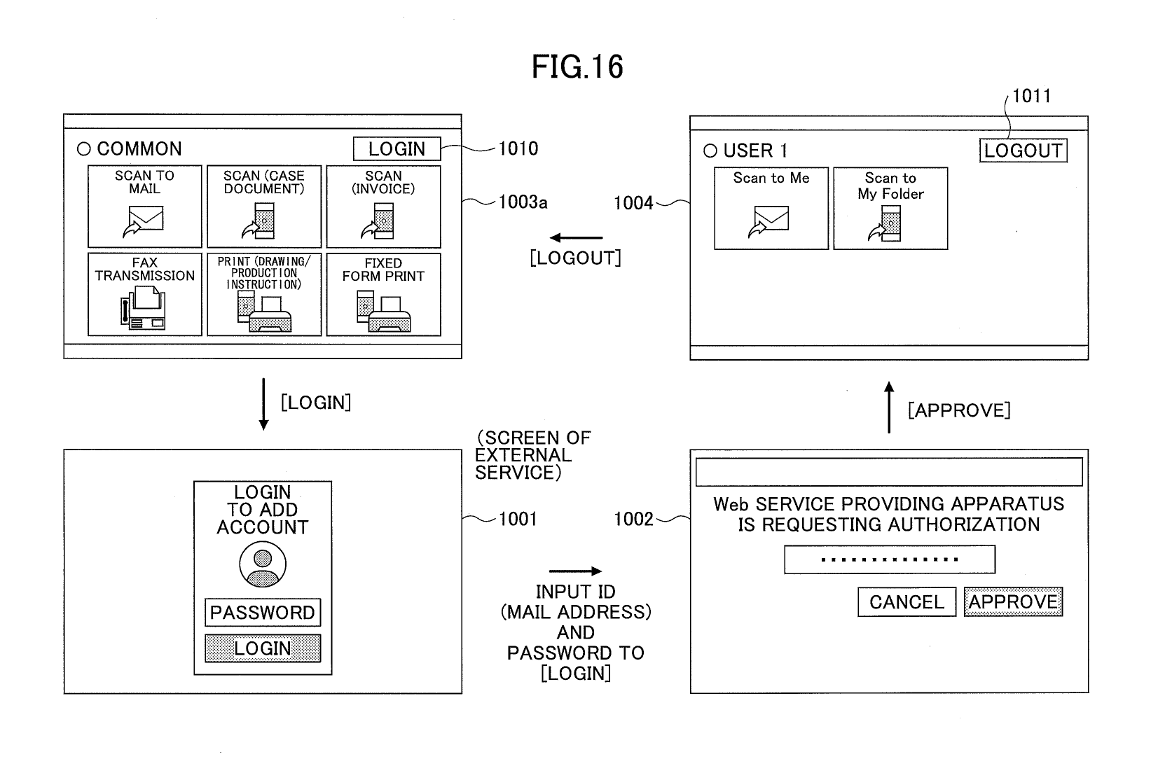

In order to jointly use the personal authentication, in the information processing system 1 according to the second embodiment, the image forming apparatus 12 displays an application screen 1003a as illustrated in FIG. 16 where a login button 1010 is arranged on the application screen 1003 of the operation flow of FIG. 9.

When the user pushes the login button 1010, the image forming apparatus 12 displays the authorization screen 1001 of the external service providing system 30. The user inputs an ID (mail address) and a password to the authorization screen 1001 and pushes the approve button in the authorization screen 1002 to request the authorization processing. When the authorization is successful, the image forming apparatus 12 obtains application information for personal use from the external service providing system 30, and uses the obtained application information to display an application screen 1004 for personal use. In this case, the application screen 1004 is for “USER 1” as illustrated in FIG. 16.

A logout button 1011 is arranged in the application screen 1004 for personal use. When the user pushes the logout button 1011, the image forming apparatus 12 returns and displays the application screen 1003a for the tenant.

<<Personal Authentication>>

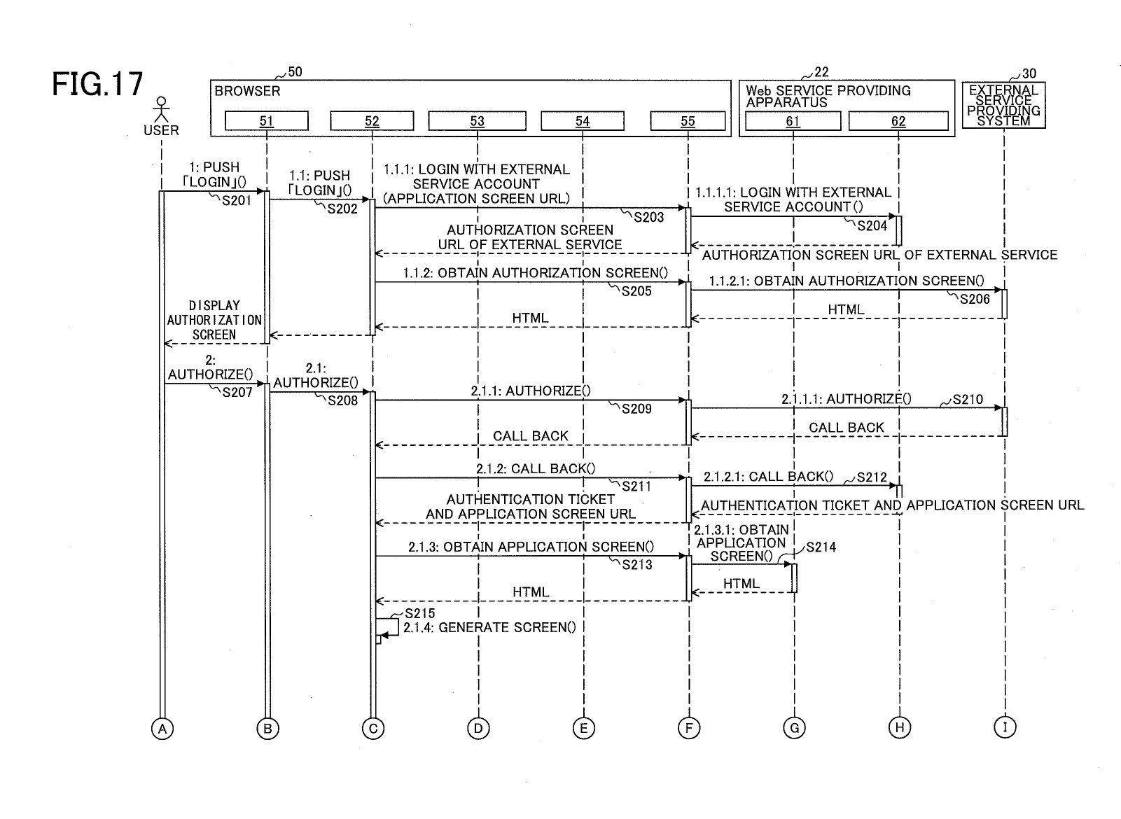

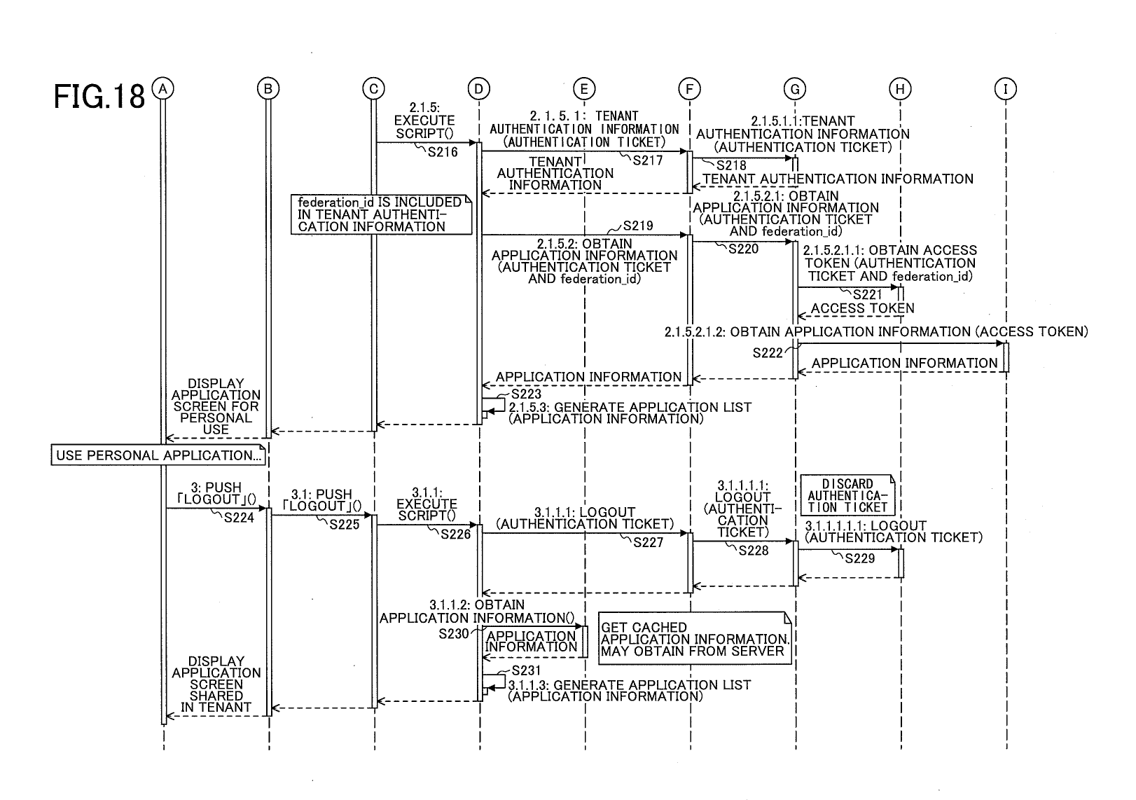

The image forming apparatus 12 displays the application screen 1004 for personal use according to procedures as illustrated in FIGS. 17 and 18. FIGS. 17 and 18 illustrate a sequence chart illustrating an example of processing for displaying the application screen 1004 for personal use. Here, FIGS. 17 and 18 illustrate processing after the application screen 1003a for the tenant is displayed.

In step S201, the user pushes the login button 1010 of the application screen 1003A for the tenant. In step S202, the display/input unit 51 of the image forming apparatus 12 notifies the screen generating unit 52 that the login button 1010 of the application screen 1003a for the tenant is pushed.

In steps S203 and S204, the screen generating unit 52 designates the URL of the application screen to perform, on the authentication/authorization service 62 of the Web service providing apparatus 22, the login with the account of the external service. The authentication/authorization service 62 returns the URL of the authorization screen 1001 of the external service providing system 30 to the screen generating unit 52 of the image forming apparatus 12.

In steps S205 and S206, the screen generating unit 52 uses the URL of the authorization screen 1001 returned from the Web service providing apparatus 22 to obtain the HTML data of the authorization screen 1001 from the external service providing system 30. The screen generating unit 52 uses the obtained HTML data of the authorization screen 1001 to cause the display/input unit 51 to display the authorization screen 1001.

In step S207, the user inputs the ID (mail address) and the password in the authorization screen 1001 and pushes the approve button in the approval screen 1002 to request the authorization processing to the display/input unit 51 of the image forming apparatus 12. In step S208, the display/input unit 51 requests the authorization processing to the screen generating unit 52.

In steps S209 and S210, the screen generating unit 52 requests, to the external service providing system 30, the authorization processing by the password and the ID (mail address) input to the authorization screen 1001. A result of the authorization processing in the external service providing system 30 is called back (returned) to the authentication/authorization service 62 of the Web service providing apparatus 22 in steps S211 and S212. When the authorization processing is successful in the external service providing system 30, the authentication/authorization service 62 returns the authentication ticket and the URL of the application screen 1003 to the screen generating unit 52 of the image forming apparatus 12.

In steps S213 and S214, the screen generating unit 52 obtains HTML data of the application screen 1004 from the application 61 of the Web service providing apparatus 22 via the communicating unit 55.

In step S215, the screen generating unit 52 generates the application screen 1004 by use of the obtained HTML data. In step S216, the screen generating unit 52 requests the script analyzing unit 53 to execute the script included in the obtained HTML data. The script analyzing unit 53 executes the script included in the HTML data to perform subsequent processing.

In steps S217 and S218, the script analyzing unit 53 requests the application 61 of the Web service providing apparatus 22 to obtain the tenant authentication information designating the authentication ticket. The application 61 generates the tenant authentication information according to procedures similar to the procedures in steps S41 to S43 of FIG. 11. The application 61 returns the generated tenant authentication information to the script analyzing unit 53 of the image forming apparatus 12.

In steps S219 and S220, the script analyzing unit 53 designates (uses) the authentication ticket and the federation ID included in the tenant authentication information to request the application 61 of the Web service providing apparatus 22 to obtain the application information.

In step S221, the application 61 designates the authentication ticket and the federation ID to request the authentication/authorization service 62 to obtain the access token. When validity of the designated authentication ticket and the federation ID is confirmed, the authentication/authorization service 62 obtains, from the external cooperation information 67 of FIG. 7, the access token corresponding to the federation ID. The authentication/authorization service 62 returns the obtained access token to the application 61.

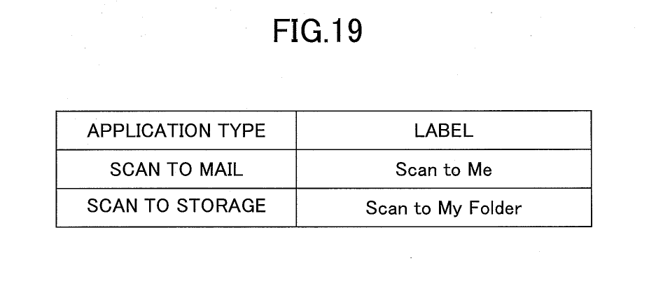

In step S222, the application 61 designates the access token to obtain the application information for personal use illustrated in FIG. 19 from the external service providing system 30 and returns the obtained application information to the script analyzing unit 53. FIG. 19 is a table illustrating an example of the application information for personal use.

In step S223, the script analyzing unit 53 generates an application list for personal use from the application information for personal use to display the application screen 1004 for personal use including the application list for personal use on the display/input unit 51.

In step S224, the user pushes the logout button 1011 of the application screen 1004 for the user. In step S225, the display/input unit 51 of the image forming apparatus 12 notifies the screen generating unit 52 that the logout button 1011 of the application screen 1004 for the user is pushed.

In step S226, the screen generating unit 52 requests the script analyzing unit 53 to execute the script corresponding to the pushing of the logout button 1011. The script analyzing unit 53 executes the script included in the HTML data to perform subsequent processing.

In steps S227 and S228, the script analyzing unit 53 designates the authentication ticket to request the logout to the application 61 of the Web service providing apparatus 22. The application 61 designates the authentication ticket to request the logout to the authentication/authorization service 62 and causes the authentication/authorization service 62 to discard the authentication ticket.

In step S230, the script analyzing unit 53 of the image forming apparatus 12 obtains the application information for the tenant from the data storing unit 54. In step S231, the script analyzing unit 53 generates an application list for the tenant from the application information for the tenant to display the application screen 1003a including the application list for the tenant on the display/input unit 51.

In a case of displaying the application screen 1003a for the tenant, the image forming apparatus 12 uses the tenant authentication information to obtain the application information for the tenant. In a case of displaying the application screen 1004 for the user, the image forming apparatus 12 uses the authentication ticket and the federation ID to obtain the application information for the user. In other words, the script analyzing unit 53 uses information representing that the user has been authenticated or the tenant authentication information stored in the data storing unit 54 to request the Web service providing apparatus 22 to provide the service for the user or for the tenant. Further, when the logout button 1011 arranged in the application screen 1004 for the user is pushed, the authentication/authorization service 62 of the Web service providing apparatus 22 discards the authentication ticket.

Although the authentication ticket and the federation ID are used to obtain the application information for the user in the sequence chart illustrated in FIGS. 17 and 18, the tenant authentication information may be used.

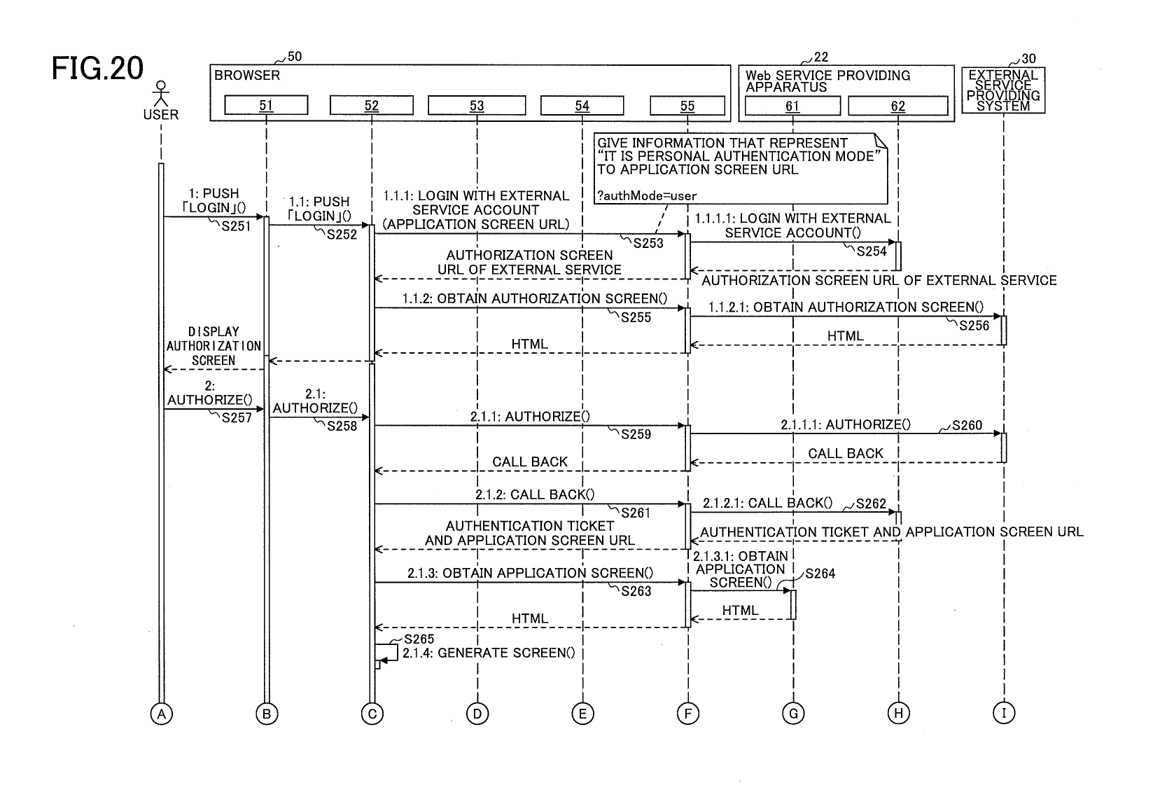

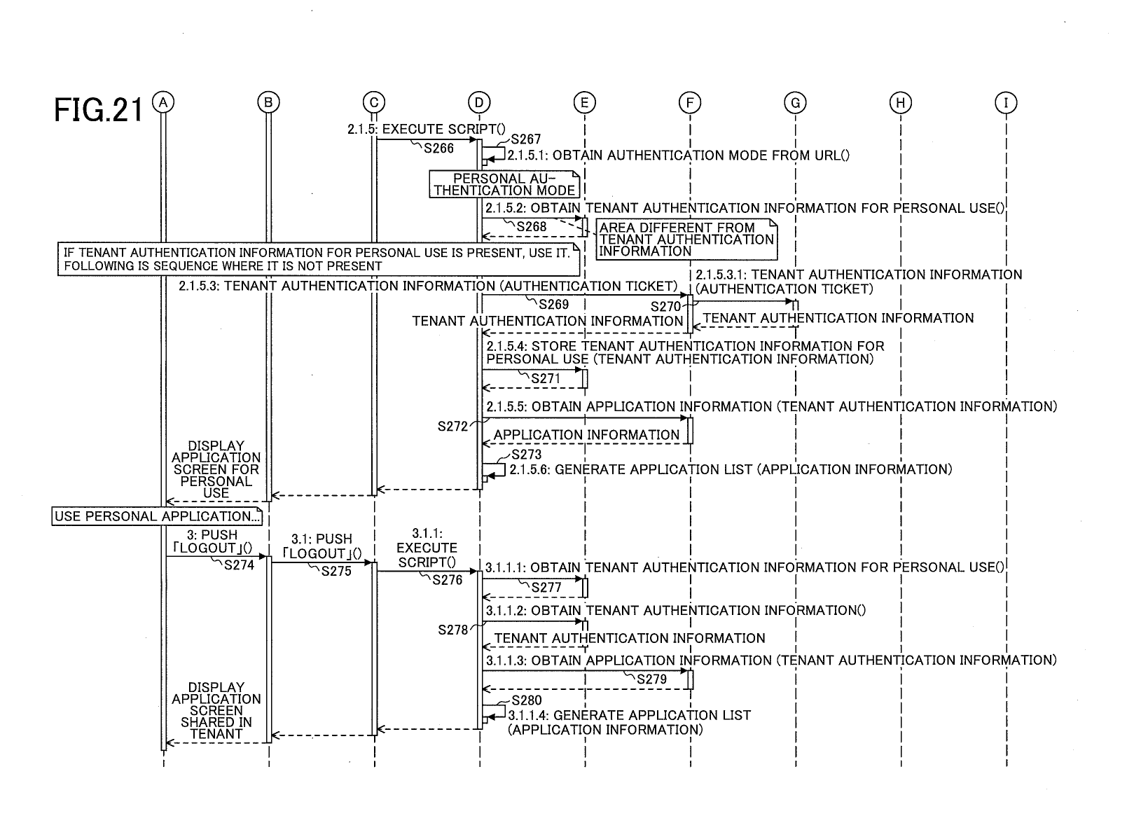

FIGS. 20 and 21 illustrate a sequence chart illustrating another example of processing for displaying the application screen for personal use. FIGS. 20 and 21 illustrate processing after the application screen 1003a for the tenant is displayed. In the sequence chart of FIGS. 20 and 21, an authentication mode is given to the URL of the application screen such that determination of whether the application screen is currently used in the tenant authentication or used in the personal authentication can be made.

For example, the URL of the application screen, to which the authentication mode is given, is represented as “https://example.com/app?authMode=user”.

In step S251, the user pushes the login button 1010 of the application screen 1003a for the tenant. In step S252, the display/input unit 51 of the image forming apparatus 12 notifies the screen generating unit 52 that the login button 1010 of the application screen 1003a for the tenant is pushed.

In steps S253 and S254, the screen generating unit 52 designates the URL of the application screen to perform, on the authentication/authorization service 62 of the Web service providing apparatus 22, the login with the account of the external service. Information “?authMode=user”, representing the personal authentication mode, is given to the designated URL of the application screen. The authentication/authorization service 62 returns the URL of the authorization screen 1001 of the external service providing system 30 to the screen generating unit 52 of the image forming apparatus 12.

Because processes in steps S255 to S266 are similar to the processes in steps S205 to S216 of FIGS. 17 and 18, descriptions of the processes in steps S255 to S266 are omitted. In step S267, the script analyzing unit 53 obtains information that represents the authentication mode from the application screen URL. Here, a case is described where the information that represents the personal authentication mode is obtained.

In step S268, the script analyzing unit 53 checks whether tenant authentication information for personal use has been stored in the data storing unit 54. The data storing unit 54 has an area that stores the tenant authentication information for personal use and an area that stores the tenant authentication information for the tenant. Here, these areas are separated. When tenant authentication information for personal use has been stored in the data storing unit 54, the script analyzing unit 53 uses the tenant authentication information for personal use. Here, an example will be described where the tenant authentication information for personal use has not been stored in the data storing unit 54.

In steps S269 and S270, the script analyzing unit 53 requests the application 61 of the Web service providing apparatus 22 to obtain the tenant authentication information designating the authentication ticket. The application 61 generates the tenant authentication information according to procedures similar to the procedures in steps S41 to S43 of FIG. 11. The application 61 returns the generated tenant authentication information to the script analyzing unit 53 of the image forming apparatus 12.

In step S271, the script analyzing unit 53 stores the tenant authentication information for personal use in the data storing unit 54. In step S272, the application information for personal use is obtained by processes similar to the processes in steps S45 to S48 of FIG. 11.

In step S273, the script analyzing unit 53 generates the application list for personal use from the application information for personal use to display the application screen 1004 for personal use including the application list for personal use on the display/input unit 51.

In step S274, the user pushes the logout button 1011 of the application screen 1004 for the user. In step S275, the display/input unit 51 of the image forming apparatus 12 notifies the screen generating unit 52 that the logout button 1011 of the application screen 1004 for the user is pushed.

In step S276, the screen generating unit 52 requests the script analyzing unit 53 to execute the script corresponding to the pushing of the logout button 1011. The script analyzing unit 53 executes the script included in the HTML data to perform subsequent processing.

In steps S277 and S278, the script analyzing unit 53 obtains, from the data storing unit 54, the tenant authentication information for personal use and the tenant authentication information for the tenant. In step S279, the application information for the tenant is obtained by processes similar to the processes in steps S45 to S48 of FIG. 11. In step S280, the script analyzing unit 53 generates the application list for the tenant from the application information for the tenant to display the application screen 1003a including the application list for the tenant on the display/input unit 51.

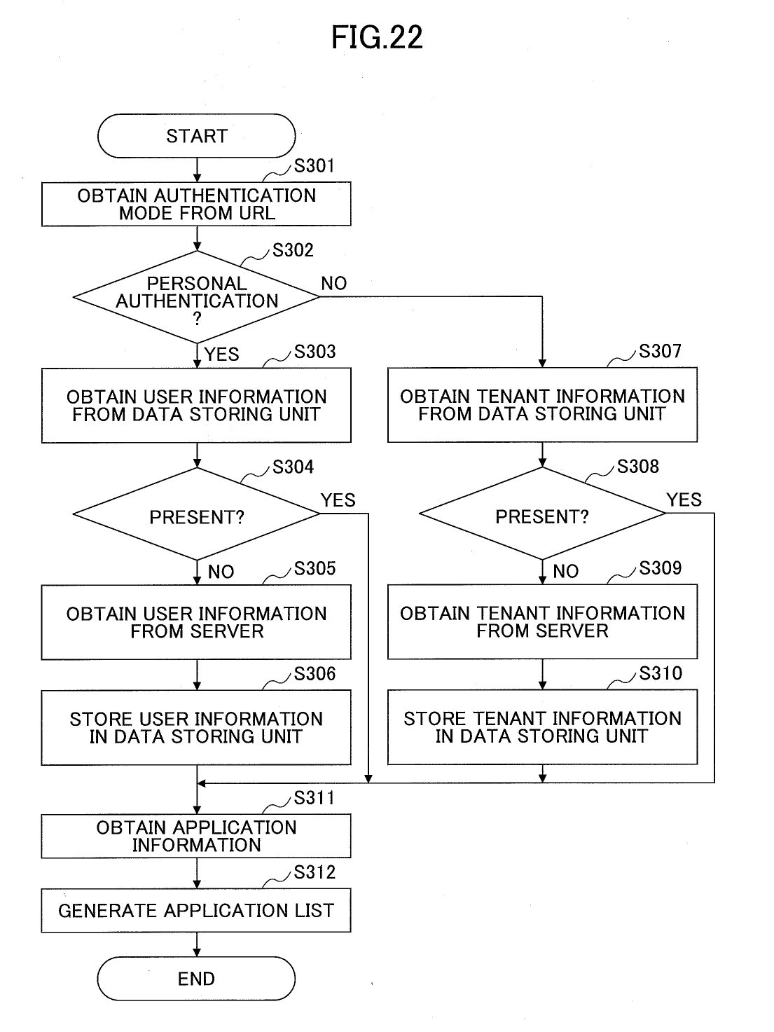

FIG. 22 is a flowchart illustrating an example in a case where the authentication mode is used to perform personal authentication. The script analyzing unit 53 obtains information that represents the authentication mode from the URL of the application screen in step S301. When the information, representing the authentication mode, represents the personal authentication (YES in step S302), the script analyzing unit 53 confirms whether the user information 66 is present (stored) in the data storing unit 54 in steps S303 and S304.

When the user information 66 is not present (NO in step S304), the script analyzing unit 53 obtains the user information 66 from the Web service providing apparatus 22 in step S305. In step S306, the script analyzing unit 53 stores the obtained user information 66 in the data storing unit 54. Here, when the user information 66 is present (YES in step S304), the script analyzing unit 53 skips the processes in steps S305 and S306.

When the information, representing the authentication mode, represents the tenant authentication (NO in step S302), the script analyzing unit 53 confirms whether the tenant information 65 is present (stored) in the data storing unit 54 in steps S307 and S308. When the tenant information 65 is not present (NO in step S308), the script analyzing unit 53 obtains the tenant information 65 from the Web service providing apparatus 22 in step S309.

In step S310, the script analyzing unit 53 stores the obtained tenant information 65 in the data storing unit 54. Here, when the tenant information 65 is present (YES in step S308), the script analyzing unit 53 skips the processes in steps S309 and S310.

In step S311, the script analyzing unit 53 obtains the application information for personal use or for the tenant. In step S312, the script analyzing unit 53 generates the application list for personal use or for the tenant.

Further, the present disclosure is not limited to the specifically described embodiments, but various variations and modifications may be made without departing from the scope of the present invention.

The external service providing system 30 is an example of a first service providing system disclosed in claims. The Web service providing apparatus 22 is an example of a second service providing system or an information processing system. The image forming apparatus 12 is an example of an electronic device.

The tenant access key is an example of information for performing the authentication by the organization to which the user belongs. In other words, the tenant access key is an example of information for authenticating the organization to which the user belongs. The federation ID is an example of information for identifying the service. The tenant authentication information is an example of authentication information. The data storing unit 54 is an example of a data storing unit. The request to display the application (application displaying request) is an example of a request to use the service. The script analyzing unit 53 is an example of a requesting unit. The display/input unit 51 is an example of a display/input unit.

The screen generating unit 52 is an example of a screen generating unit. The application information is an example of information obtained from the first service providing system. The application screen is an example of a screen of the service. The authentication/authorization service 62 is an example of an information providing unit. The application 61 is an example of a processing unit.

What is claimed is:

1. An electronic device for receiving a service relating to an application that is in cooperation with a first service providing system from a second service providing system, the electronic device comprising:
a data storing unit configured to store authentication information, which includes information for authenticating an organization to which a user belongs and information for identifying the service, after authentication processing performed on the first service providing system succeeds; and
a requesting unit configured, in a case where the authentication information has been stored in the data storing unit when a request to use the service is received from the user, to use the authentication information stored in the data storing unit to request the second service providing system to provide the service.

2. The electronic device according to claim 1, further comprising:
a display/input unit configured, in a case where the authentication information has not been stored in the data storing unit when the request to use the service is received from the user, to display a screen for prompting the user to perform the authentication processing on the first service providing system.

3. The electronic device according to claim 2, wherein the display/input unit is configured, in a case where the authentication information has been stored in the data storing unit when the request to use the service is received from the user, to display a screen of the service without displaying the screen for prompting the user to perform the authentication processing on the first service providing system.

4. The electronic device according to claim 1, further comprising:
a screen generating unit configured, when the request to use the service is received from the user, to obtain screen data for generating a screen of the service from the second service providing system to cause the requesting unit to execute a program included in the screen data.

5. The electronic device according to claim 4, wherein the screen generating unit displays, on the screen of the service, information obtained by the second service providing system from the first service providing system.

6. An information processing system comprising:
an electronic device; and
a second service providing system configured to provide, to the electronic device, a service relating to an application that is in cooperation with a first service providing system,
wherein the electronic device includes:
a data storing unit configured to store authentication information, which includes information for authenticating an organization to which a user belongs and information for identifying the service, after authentication processing performed on the first service providing system succeeds; and
a requesting unit configured, in a case where the authentication information has been stored in the data storing unit when a request to use the service is received from the user, to use the authentication information stored in the data storing unit to make a request to the second service providing system for providing the service, and
wherein the second service providing system includes:
an information providing unit configured to provide information for using the first service providing system in response to the request from the requesting unit using the authentication information; and
a processing unit configured to use the first service providing system by use of the information for using the first service providing system to perform processing for providing the service requested from the requesting unit.

7. The information processing system according to claim 6, wherein the electronic device includes a display/input unit configured, in a case where the authentication information has not been stored in the data storing unit when the request to use the service is received from the user, to display a screen for prompting the user to perform the authentication processing on the first service providing system.

8. The information processing system according to claim 6, wherein the electronic device includes a screen generating unit configured, when the request to use the service is received from the user, to obtain screen data for generating a screen of the service from the second service providing system to cause the requesting unit to execute a program included in the screen data.

9. The information processing system according to claim 8, wherein the screen generating unit displays, on the screen of the service, information obtained by the second service providing system from the first service providing system.

10. The information processing system according to claim 9,
wherein the data storing unit stores the information obtained by the second service providing system from the first service providing system, and
wherein the screen generating unit displays, on the screen of the service, the information stored in the data storing unit when the information, obtained by the second service providing system from the first service providing system, has been stored in the data storing unit.

11. The information processing system according to claim 6, the requesting unit uses information representing that the user has been authenticated or the authentication information stored in the data storing unit to request the second service providing system to provide the service for the user or for the organization.

12. An information processing method executed by an information processing system, the information processing system including an electronic device and a second service providing system for providing, to the electronic device, a service relating to an application that is in cooperation with a first service providing system, the information processing method comprising:
causing the electronic device to store, in a data storing unit, authentication information, which includes information for authenticating an organization to which a user belongs and information for identifying the service, after authentication processing performed on the first service providing system succeeds;
causing the electronic device to use the authentication information stored in the data storing unit to make a request to the second service providing system for providing the service in a case where the authentication information has been stored in the data storing unit when a request to use the service is received from the user;
causing the second service providing system to provide information for using the first service providing system in response to the request from the electronic device using the authentication information; and
causing the second service providing system to use the first service providing system by use of the information for using the first service providing system to perform processing for providing the service requested from the electronic device.
